(19) United States
(12) Patent Application Publication
(10) Pub. No.: US 2018/0105051 A1
(43) Pub. Date: Apr. 19, 2018

(54) Method and system for managing charging stations

(71) Applicants: Joyce A. Zheng, Cupertino, CA (US); Joe Zheng, Cupertino, CA (US)

(72) Inventors: Joyce A. Zheng, Cupertino, CA (US); Joe Zheng, Cupertino, CA (US)

(21) Appl. No.: 15/297,151

(22) Filed: Oct. 19, 2016

(51) Int. Cl. B60L 11/18; H04L 29/08; G06Q 30/02; G06Q 30/04; G06Q 50/06

(52) U.S. Cl. CPC B60L 11/1824; H04L 67/12; H04L 67/306; G06Q 30/0267; G06Q 30/0269; H04B 1/3833; G06Q 30/04; G06Q 50/06; B60L 2230/16; B60L 2230/40; G06Q 30/0265

(57) ABSTRACT

Methods and systems for managing charging stations for electric vehicles are described. According to one aspect of the present invention, an identity of a user driving a vehicle and contact information are obtained when the vehicle is detected to occupy a charging station or charger for charging the vehicle. The user is then periodically updated of the charging status and notified of the completion when the charging has reached to the full capacity of battery in the vehicle or a predefined charging level set by the user. A fee is assessed when the vehicle has not been removed from the charger after a predefined period (e.g., 5 minutes). As a result, a charging station or a charger can be used more efficiently as the demand for charging stations and the EVs are getting popular.

### BACKGROUND OF THE INVENTION

### Field of the Invention

The present invention is related to the area of electrical vehicles, and more particularly related to method and system for managing charging stations for electrical vehicles.

### Description of the Related Art

All-electric vehicles (EVs) run on electricity only. They are propelled by one or more electric motors powered by rechargeable battery packs. An electric vehicle (EV), also referred to as an electric drive vehicle, uses one or more electric motors or traction motors for propulsion. An electric vehicle may be powered through a collector system by electricity from off-vehicle sources, or may be self-contained with a battery or generator to convert fuel to electricity.

In general, EVs have several advantages over vehicles with internal combustion engines in the areas of energy efficiency, environment, performance benefits, and energy independence as electricity is a domestic energy source. EVs do, however, face significant battery-related challenges, one of which is that they need to be charged from time to time. Unlike gasoline stations that are almost everywhere, electricity charging stations for the EVs are relatively new and still growing in numbers across the country.

To support their EVs, Tesla is building a network of 480-volt fast-charging stations to allow longer journeys for their thorough quick charging of a vehicle's battery packs. Tesla began building the network in 2012. As of September 2016, there were over 700 stations globally with over 4000 chargers. To control the global warming and promote the EVs, many local cities, parking lots or businesses in US have started to build or install EV charging stations for their residents, customers or employees to charge their vehicles at a fee or marginal cost. For the best use of these charging stations, they are typically built along or near an express way (e.g., highway or freeway), buildings, a library, a movie theater, a shopping mall or the like, where parking is usually in high demand. As a result, some EV owners would go away to do other things while their vehicles are being charged, occupying a charging station much longer than necessary. Worse, an unthoughtful EV owner may take a charging station as a convenient parking spot when parking spaces near a crowded place are almost occupied.

With the popularity of the EVs, the demand for these EV charging stations will be dynamically and exponentially increased. Occupying a charging station even after an EV has been completely charged would cause inconvenience to other EV owners or at least reduce the amount of available charging stations. Thus there is a great need for managing the use of the EV charging stations.

To promote EVs so as to reduce the pollution and energy dependence, some free charging stations may be provided. However, there is a need for financial resource to cover the cost of operating such free charging station. As more users are in need of charging their vehicles, it is neither safe nor convenient to line up in vehicles in a limited space for next available chargers. This could cause traffic at a charging station. Thus there is yet another need for solutions of arranging the users to come at an appropriate time for using a next available charger.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

In general, the present invention is related to methods and systems for managing charging stations for electric vehicles. According to one aspect of the present invention, an identity of a user driving a vehicle and contact information are obtained when the vehicle is detected to occupy a charging station or charger for charging the vehicle. The user is then periodically updated of the charging status and notified of the completion via his/her smartphone or vehicle screen when the charging has reached to the full capacity of battery in the vehicle or a predefined charging level set by the user. A fee is assessed when the vehicle has not been removed from the charger after a predefined period (e.g., 5 minutes). As a result, a charging station or a charger can be used more efficiently as the demand for charging stations and the EVs are getting increasingly popular.

According to another aspect of the present invention, a marketing or advertising campaign is initiated while a user is waiting for his/her vehicle being charged. Depending on where the user is, an advertising stream may be pushed or streamed to a display within the vehicle if the user is detected waiting in the vehicle or an application (App) provided to interact with the vehicle or receive a notification from the vehicle or a server.

According to still another aspect of the present invention, a business operating free charging stations may supplement the cost of operating such charging stations by requiring users to receive the advertisement while their vehicles are being charged at the stations.

According to still another aspect of the present invention, a profile of the user may be used to stream in advertisements that are allocated per the profile. Based on possible interactions between an advertisement and the user viewing the advertisement, the profile is updated and user to further determine what advertisements may be more interesting to the user. With stored cookies based on what the user has browsed or shopped on the Internet, advertisements allocated for the user based on the cookies are likely to attract the attention of the user while the user is waiting for the vehicle being charged.

According to still another aspect of the present invention, when a vehicle is detected to have occupied a charger while the vehicle is not being charged, a notification is initiated. If the user has signed in, a notification is sent to the user (e.g., a corresponding App, a text or email) to ask the user starting the charging or ask the user to make the charger available for a next user who really needs the charger. After a predefined period, a notification is sent to an officer or a staff member nearby to ticket the vehicle or ask the user to move the vehicle off the charger.

According to yet another aspect of the present invention, users may sign in for a charging station to avoid physically sitting in vehicles waiting in a line when the demand for chargers at the charging stations is high. A user receives a notification when a charger is about to be available to give the user enough time to arrive for using the charger. The estimated time may be calculated based on where the user is and the distance to the charging station, optionally the traffic conditions therebetween. Should the user give up the spot or be considerably late, a next user will be automatically chosen for the charger. As a result, there is no need for drivers sitting in their vehicles lining up at a charging station with limited space for a next available charger. Further drivers are able to check their smartphones to know the availability of EV chargers prior to arriving at the charging station. Drivers can also view the current waiting list for the chargers at a chosen location.

The present invention may be implemented in software or in a combination of software and hardware, and practiced as a system, a process, or a method. According to one embodiment, the present invention is a method for managing a charging station for electrical vehicles, the method comprises: detecting whether a vehicle has occupied a charger at the charging station; checking the availability/wait list at a specific charging station prior to arrival at the station; requiring a user of the vehicle to sign in with the charging station when the vehicle is detected at the charger; notifying the user wirelessly from time to time about a charging status of the vehicle; sending a notification to the user when the vehicle has been charged to a full capacity of battery in the vehicle or to a predefined level; and charging an account of the user for a fee when the user had not removed the vehicle from the charger after a predefined time.

According to another embodiment, the present invention is a system for managing a charging station for electrical vehicles, the system comprises: at least one charger at the charging station, the charger coupled to a data network; and a detector disposed near the charger, wherein a user of the vehicle is required to sign in with the charging station when the charger detects the vehicle occupying the charger, the user is wirelessly notified from time to time about a charging status of the vehicle and the charger causes a notification to be sent to the user when the vehicle has been charged to a full capacity of battery in the vehicle or to a predefined level; and an account of the user is charged for a fee when the user had not removed the vehicle from the charger after a predefined time. The system further comprises at least one server managing a plurality of charging stations located remotely with respect to each other, the server communicating with the vehicle and an application running in a mobile device associated with the user. The server is uniquely designed, configured or made to determine how many chargers are being used at the charging station, determine when one of the chargers will become available next, and calculate the estimated time for using an available charger.

One of the objectives, features, and advantages of the present invention is to provide techniques for managing a charging station and maximizing the use of each of chargers at a charging station. Another one of the objectives, features, and advantages of the present invention is to provide a mechanism of minimizing possible abuse of a charger, especially when the charger is disposed at a place where parking is always in high demand.

Other objectives, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 shows a basic system configuration in which the present invention may be practiced in accordance with one embodiment thereof;

FIG. 2A shows a flowchart or process of managing a charging station;

FIG. 2B shows an example of three chargers A, B and C in three exemplary statuses;

FIG. 2C shows an example of using a mobile device to sign in with a charging station;

FIG. 2D shows a display of a mobile device showing an example of a confirmation;

FIG. 3A shows a flowchart or process of providing advertisements to the users that use the free charging stations according to one embodiment of the present invention;

FIG. 3B shows an example of personalized advertisement 320 from an advertiser based on the profile of the user;

FIG. 4A shows a flowchart or process of reserving a charger prior to arriving at a charging station;

FIG. 4B shows a top-view of an exemplary charging station that includes at least two chargers and a number of parking spots; and

FIG. 5 shows a functional block diagram of a server in which a server module resides in a memory space and is executed by one or more processors according to one embodiment of the present invention.

### DETAILED DESCRIPTION OF THE PREFERRED EMBODIMENTS

The present invention pertains to a platform that is designed to manage a charging station or a network of charging stations. The platform contemplated in the present invention facilitates the control of using a charging station and maximizes the use of the charging station. By using one embodiment of the platform, the possibility of abusing a charging station may be minimized, resulting in the maximum use of the charging station. As will be appreciated in the description hereinafter, many interactions between a user and a charging station or an operator thereof are automatic and performed through a client-server architecture.

The detailed description of the present invention is presented largely in terms of procedures, steps, logic blocks, processing, or other symbolic representations that directly or indirectly resemble the operations of data processing devices. These descriptions and representations are typically used by those skilled in the art to most effectively convey the substance of their work to others skilled in the art. Numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, as used herein, any pronoun references to gender (e.g., he, him, she, her, etc.) are meant to be gender-neutral. Unless otherwise explicitly stated, the use of the pronoun “he”, “his” or “him” hereinafter is only for administrative clarity and convenience. Additionally, any use of the singular or to the plural shall also be construed to refer to the plural or to the singular, respectively, as warranted by the context.

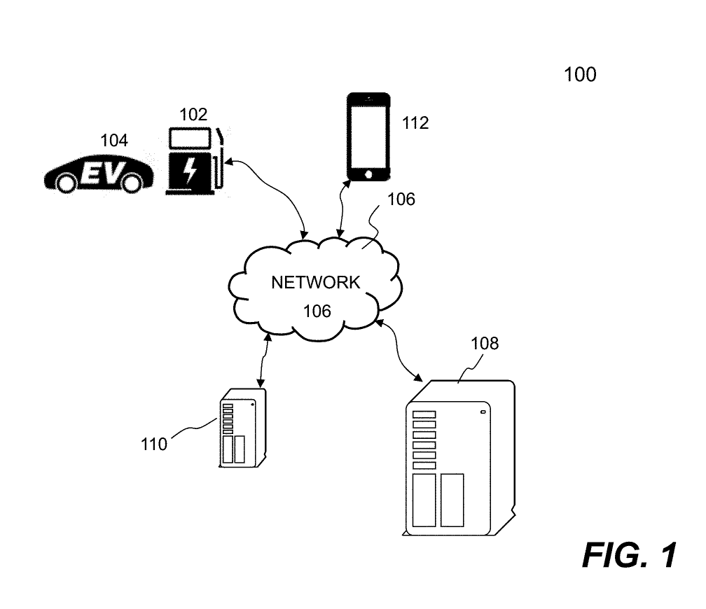

Referring now to the drawings, in which like numerals refer to like parts throughout the several views. FIG. 1 shows a basic system configuration 100 in which the present invention may be practiced in accordance with one embodiment thereof. A charging station 102 is shown to be online, coupled to a data network 106 (e.g., a wireless or wired net, the Internet, 3G, LTE or 5G), where the charging station 102 represents a single charger or an array of chargers at one site. Unless explicitly stated, a charger or a charging station may be interchangeably used herein. In general, the charging station or a charger 102 is designed for charging one EV 104. Those skilled in the art can appreciate that one embodiment of the present invention is equally applicable for a charger designed for charging multiple EVs at a time.

By connecting to the network 106, the charging station 102 can report to an operator thereof via a server 108 a status (e.g., occupied, in charging or available). At the same time, the operator can closely monitor the charging station 102 if needed and control the operation of the charging station 102. For example, in the event of declared or detected emergency nearby that may be detrimental to the operation of a charging station or a vehicle using the charging station, the operator may shut down the charging station 102 via the server 108.

According to one embodiment, the server 108 represents a single server or a collection of servers operated by an operator or a business that runs all the charging stations 102 in a region or across a country. The server 108 communicates with each of the charging stations, collects status data and monitors the operation of each of the charging stations. In one embodiment, the server 108 communicates with users using the charging stations and keeps them informed of the charging status of their vehicles. In another embodiment, the server 108 issues a reminder to a user when it is detected that his vehicle remains occupying a charger beyond a reasonable time even after his vehicle has already been fully charged. In still another embodiment, the server 108 starts assessing a fee to the user for occupying a charger after a predefined time (e.g., 5 minutes, 10 minutes, or 30 minutes after the charging is already complete).

Depending on the situation, the fee may be rated accordingly. For example, when a charging station is in a parking lot and may be used without paying the normal parking rate. After it is detected that a user has occupied the charging station beyond a predefined time, the user is charged for the normal parking rate or more if there are other users are waiting for the charging station. Similarly, in the case of free charging provided to support EVs, a user is charged for a fee should the user keep his vehicle at the free charging station beyond a certain period after his vehicle has been charged to a predefined level (e.g., full capacity of the battery or 90% of the battery capacity).

Also shown in FIG. 1, there is a server 110 that represents a publisher of advertisements, an advertiser or a business that wishes to advertise its products or services via the server 108. While a vehicle is being charged, a user may sit in the vehicle or wait nearby. This waiting period offers a great opportunity to run advertisements to the user. As will be further described below, such advertisements may be shown on a mobile device 112 the user is using to receive the status of his vehicle being charged or an interior display screen in the vehicle since many EVs are also connected to the network 106 (e.g., Tesla Model S or Model X). According to one embodiment, the revenue received by the operator of the charging stations may be used to supplement the cost of providing complementary electricity charging to the EVs or operating the charging stations.

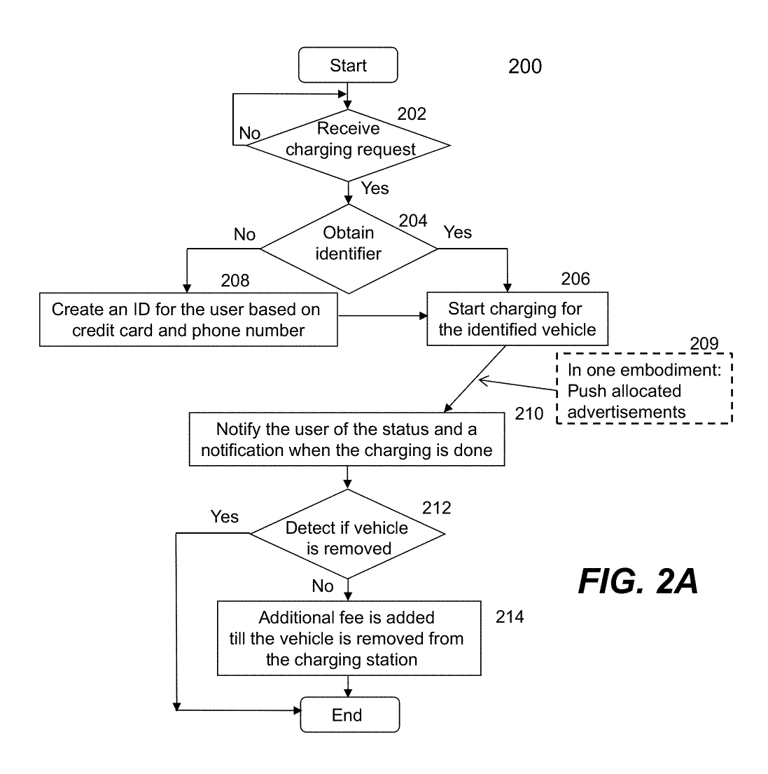

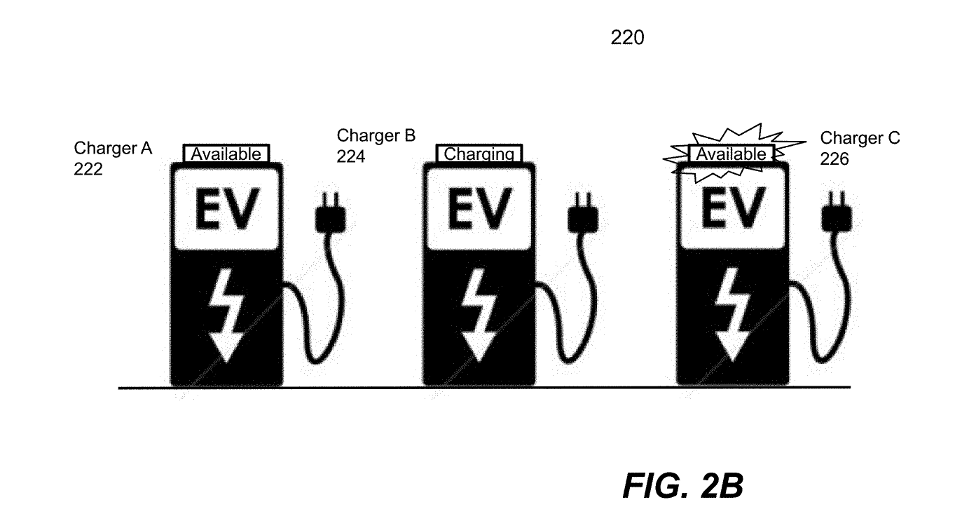

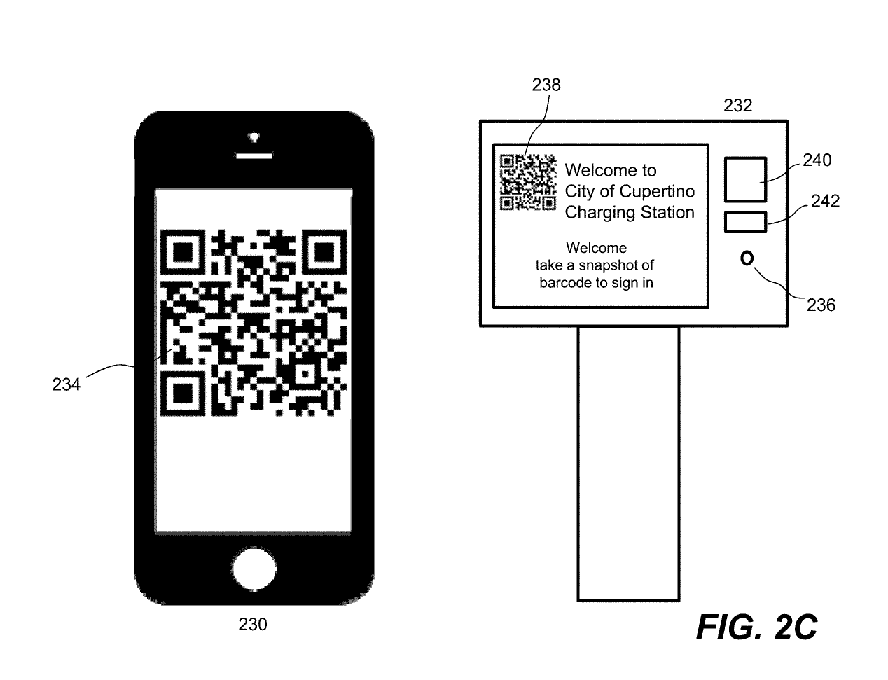

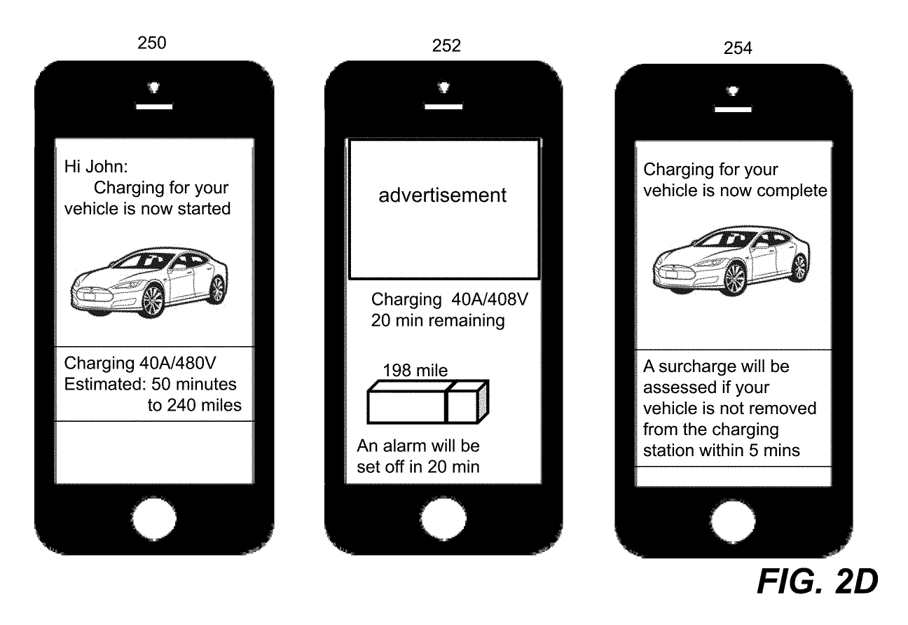

Referring now to FIG. 2A, it shows a flowchart or process 200 of managing a charging station. Depending on implementation, the process 200 may be implemented in software or a combination of software and hardware. The process 200 is initiated when a vehicle is driven or parked next to a charging stand or charger. When a vehicle is parked adjacent to a charger, the presence of the vehicle can be detected in many ways (e.g., a camera or sensor). The detail of detecting a vehicle at a specified location is not further described herein to avoid obscuring aspects of the present invention.

FIG. 2B shows an example of three chargers A, B and C or charges 222, 224 and 226 in three exemplary statuses. As explicitly shown, charger A is now available, which means that it is not occupied and ready to be used for charging a vehicle. Charger B is being occupied by a vehicle and in the middle of charging the vehicle. Charger C is also available but being occupied by a vehicle, which means charger C cannot be used even though it is available. According to one embodiment, a sign indicating the availability of the charger is flashing as Charger C shows, hoping to draw the attention of the owner of the vehicle to move his vehicle immediately. There are many ways to make this available but occupied charger to show itself differently from other chargers, which also helps indicate to other users waiting in line that this charger may soon be released.

Return now to FIG. 2A, a charger at 202 is made to determine whether it has received a charging request from a user or a driver who has just occupied the charger. If the user fails to initiate a charging request, that means the user has just used the space for EV charging as his convenient parking. Depending on the implementation, the charger may send a notification to a law officer to ticket the vehicle or a staff member/operator to tow the vehicle. It is assumed that the user does come to the charger to charge his EV.

The process 200 continues to 204 where an identifier of the user is to be obtained. The purpose of an identifier is to identify who is using the charger or responsible for the vehicle using the charger. In the case of the supercharger provided by Tesla, as soon as the vehicle is plugged in, the charger or the operator of the charger knows the owner by looking up for an account of the user by a vehicle identification number (VIN) which is a unique code, including a serial number, used by the automotive industry to identify individual motor vehicles. In another case in which a user has prepaid for charging at the charging station (e.g., $50), the user may enter a set of username and password for the charger to deduct the cost of charging from his account. In the case that a user has not established an account, the user may be asked to enter some basic information (e.g., a name of the vehicle owner, vehicle information or a VIN) with a credit card. In any case, there is an account or an onsite sign-in process to establish an account so that the user may manage his charging process, track his charging history or appreciate how much savings he has achieved by using his EV over a comparable gasoline-driven vehicle.

According to one embodiment, to facilitate the sign-in process, an optical readable symbol (e.g., barcode QR code) may be used. FIG. 2C shows an example of using a mobile device 230 to sign in with a charging station 232. In this example, the mobile device 230 is caused to display a symbol 234 (e.g., QR-symbol) after a user activates an App provided by a business entity operating the charging station 232. By holding the screen towards a camera 236, the symbol 234 is captured by the camera 236, where the information about the user is extracted from the symbol 234 by the charging station 232. Once the user is verified, the user signs in and can now start charging his vehicle.

According to another embodiment, the charging station 232 can display a symbol 238 to allow the camera of the mobile device 230 to take a snapshot of the symbol 238. An App running in the mobile device 230 is caused to extract the information about the charging station 232 to facilitate the user to sign in with it, assuming the user has interacted with a keypad 240. According to yet another embodiment, the charging station 232 is provided with a reader 242 to read credit card information off a credit card presented by the user. In any case, contact information of the user is obtained by the charging station 232 or a server (e.g., the server 108 of FIG. 1). Depending on the implementation, the contact information may be a phone number that can receive a text, an email address or an identifier of the user pertaining to an App from which the user can receive a notification from the server.

Returning back again to FIG. 2A, the process 200 is now at 204. The above description has described various situations in which an identity of the user is obtained so that the user or the owner of the vehicle is known to the charging station. The process 200 goes to 206 to allow the vehicle to be charged. Should the charging station fail to recognize the user, the process 200 goes to 208 to start a sign-up process, where the user is required to present a means of payment (e.g., credit card, debit card, PayPal or mobile payment). If the user does not want to create an account with the business operating the charging station, contact information (e.g., phone number, email address, or identifier) of the user must be entered and verified. In one embodiment, the charging station is caused to send a text or a code to the phone number, the email address or the identifier (e.g., used on social network) provided by the user and requests the user to enter a corresponding text or the code (e.g., via the keypad 240 of FIG. 2C), as such the contact information is verified. The process 200 now goes to 206 from 208 to allow the vehicle to be charged.

At 210, the user periodically receives an update of his charging status. For example, when the charging is started, the user receives a confirmation of the charging as well as an estimated time of reaching to a predefined level. FIG. 2D, a display 250 shows an example of the confirmation. As an example, the display 250 also shows a photo or graphics of the vehicle. The information of the vehicle may be entered by the user himself or obtained from his account or based upon the VIN. The graphics of the vehicle may be obtained from a database containing all types of the EVs and their corresponding photos. What is important to the user may be the estimate time for the charging to reach to a predefined level (e.g., 240 miles or 90% of the full capacity on the battery). Per the estimate, the user knows how to utilize the time (e.g., sitting in the vehicle to wait, going to pick up a cup of coffee or walking around the neighborhood).

According to one embodiment, an advertisement process is initiated at 209. While the user keeps checking on his smartphone or looking at a display screen in the vehicle, one or more advertisements may be delivered and displayed to the user. A display 252 in FIG. 2D shows a status update upon a request from the user or sent periodically. The display 252 includes an advertisement that may be generic or prepared specifically for the user. The details of running the advertisements while a vehicle is being charged will be described in more detail when it is deemed proper hereinafter. For completeness, the display 254 shows a notification for the end of charging the vehicle.

When the vehicle is charged to a predefined level, the user is electronically notified at 210. A notification is sent to the user including the charging summary (e.g., total time, a number of miles and/or percentage of the battery full capability). The process 200 moves to 212 to detect if the vehicle is removed from the charging station or not within a predefined period from the moment the charging is complete or the user was notified. If the vehicle is removed, that means the charging station is now available for another vehicle to use. If the vehicle has not been removed, that means the user of the vehicle did not come back to remove his car from the charging station within a reasonable time. The process 200 goes to 212 where a fee is assessed to the account of the user. Depending on the situation, there are many ways of assessing the charge against the account of the user. For example, a standard parking rate is used besides a penalty of occupying a charging station if the charging station is installed in a garage or parking lot. A mutually agreed rate is added up to the account or charged to the credit card on file when the user opened the account with the business operating the charging account.

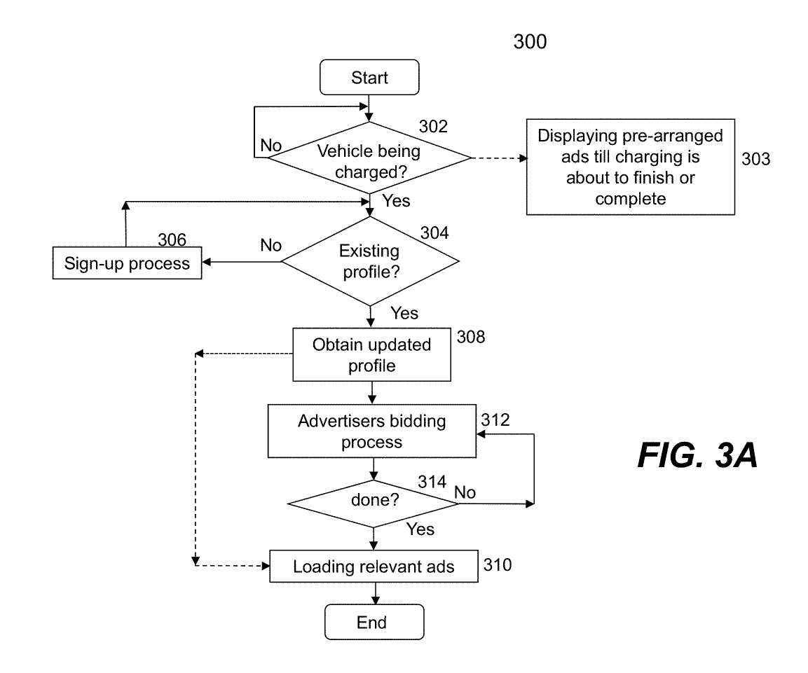

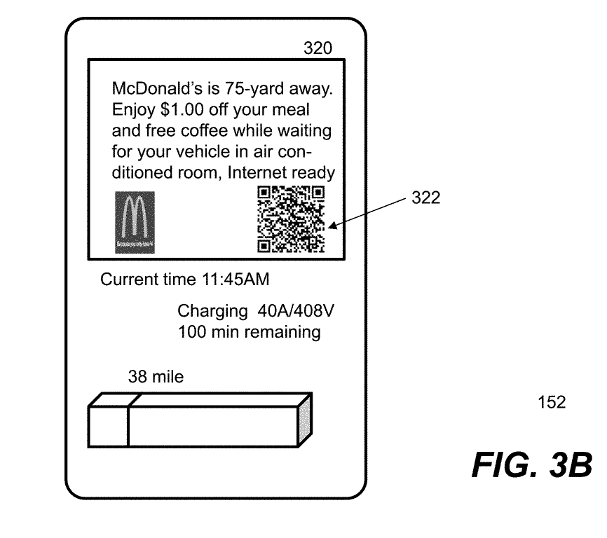

According to one embodiment, a business may offer free charging to certain types of vehicles. With the popularity of these vehicles, the demand for the free charging could go extremely high. There is a need of supplementing the cost of operating such charging stations. FIG. 3A shows a flowchart or process 300 of providing advertisements to the users that use the free charging stations according to one embodiment of the present invention. The process 300 may be implemented in software or combination of both software and hardware.

The process 300 starts when a vehicle is detected to be present for charging, where the cost of charging the vehicle may be free or lower than what other charging stations may charge. When the vehicle is being charged at 302, according to one embodiment, the process 300 goes to 303, where a set of pre-arranged advertisements is displayed on an App that the user of the vehicle is using to check the confirmation of his vehicle being charged, a periodic charging status of the vehicle or a notification of his vehicle being fully charged to a predefined level. As some advanced EVS are equipped with one or two screens on the dashboard and connected to the Internet (e.g., LTE), such a screen can also be used to feed and display the advertisements when it is detected that the user is sitting in the vehicle. The details of how to detect the presence of the user in the vehicle are well known (e.g., a sensor in a driver seat or in the vehicle) and not to be described further herein to avoid obscuring aspects of the present invention. A server in communication with the charger, the vehicle or the mobile device the user is using can feed the advertisements to a screen within the vehicle or in the smart phone.

Depending on the implementation, the advertising at 303 may not be efficient as the advertisements are generic to all. For example, a particular advertisement is related to cosmetic, it would be much more efficient if the user is a female. If the user is male, the advertisement may not make much impact on the user. The process 200 now goes to 304 to obtain a profile of the user after the user signs in with the charging station. If his profile is not available, the user may be requested to sign up either on his mobile device or with the charging station at 306. According to one embodiment, a profile of the user is available. The profile may be generated from an account created with some inputs from the user. Any extra information about the user may be used to update the profile. The example of the extra information includes, but may not be limited to, gender, age, profession, and geographic location of the user. Over the time, the profile may be updated by the interactions of the user with the display of the advertisements. Whenever a displayed advertisement is interacted by the user, a user interest is captured, resulting in the update of the profile. If the user ends up with a purchase per the advertisement, his profile is updated again. Over the time, more appropriate targeted advertisements may be allocated for the user and shown to the user when the user uses one of the charging stations operated by the business. In any case, the process 300 retrieves an updated profile of the user at 308. In one embodiment, after each advertisement, the user can choose “yes” or “no” if the advertisement is interesting or relevant to him.

The process 300 now goes to 310, where a sequence of advertisements allocated for the user per his profile is streamed to the user while his vehicle is being charged. According to another embodiment, the opportunity to stream advertisements to the user is through a bidding process 312. Instead of allocating a set of advertisements for the user based on his profile, the bidding process 312 is to open the advertising opportunity to a group of advertisers. Without releasing the identity of the user, the advertisers may be given some information of the user, for example, what car the user is driving, his current location and time, gender, age, driving habits, miles per period, frequent stops and weekend activities. The advertisers may bid at 312 for the opportunity for the business (running the charging station) to deliver their specified advertisements while the user is waiting for his vehicle being charged. For example, a restaurant chain may want to pay a higher premium to deliver its advertisement to the user when it noticed that that the user was charging his vehicle at a charging station near one of their restaurants. Such an advertisement would be appealing to the user when it is near lunchtime and the user has to wait for an hour to charge his vehicle at the charging station. At 314, a set of advertisements generated from the bidding process 312 is prepared. The business starts to deliver the advertisements at 310 via the server to the identifier user. FIG. 3B shows an example of personalized advertisement 320 from an advertiser (e.g., a chain restaurant McDonald's) based on the profile of the user. The advertisement is personalized in accordance of some of the data from the profile of the user. In particular, the location of the charging station and the time of the vehicle being charged are utilized. Should the user decide to use the advertisement while waiting or soon after the charging is done, he may display the advertisement 320 that includes a symbol 322. The symbol 322 can be scanned by the local store to effectuate the offer in the advertisement to the user.

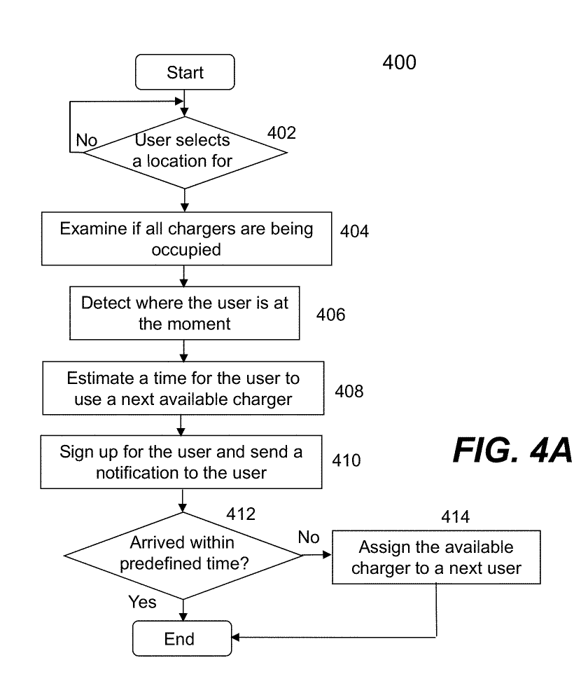

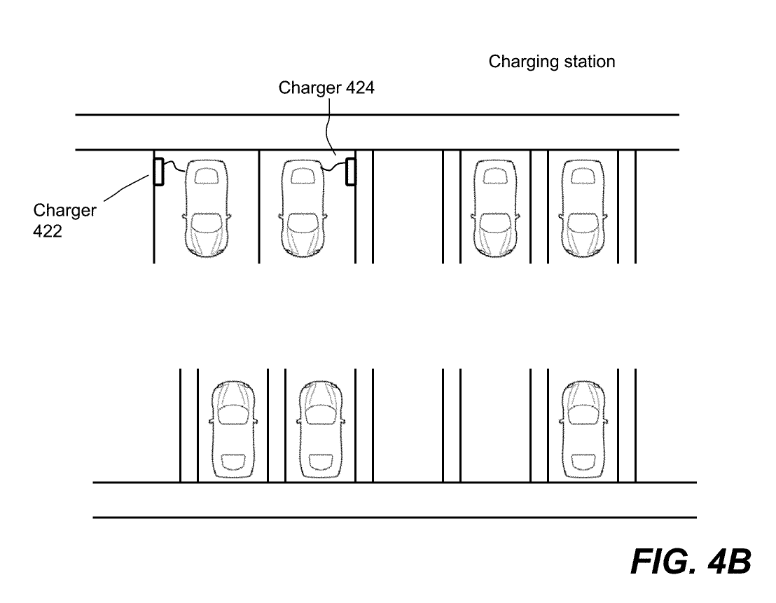

With the popularity of EVs, charging stations will be increasingly in high demand even though new charging stations are being built or installed at good pace. However, lining up for a next available charger at a charging station while sitting in vehicles is not safe. A charging station has a limited space and it takes much longer time to charge an EV than fueling up a gasoline vehicle. It would be more efficient and safer to a charging station that a vehicle arrives just before a next charger becomes available. FIG. 4A shows a flowchart or process 400 of managing a reservation at a charging station. The process 400 may be implemented in software or in combination of both software and hardware.

The process 400 starts when a driver or user has selected a charging station to charge his vehicle. A user may search for a charging station on a display within the vehicle or his mobile device and enter his selection. At 402, a request is sent by the user, either from the vehicle or the mobile device. According to one embodiment, the request includes a user ID, a timestamp and a location of where the vehicle is. Upon receiving the request, a server (e.g., the server 108 of FIG. 1) is designed at 404 to examine the status of all chargers at the selected charging station. If some of the chargers are not occupied, a response is sent back to the user to let the user know that there is no wait at the moment. If all the chargers are somehow occupied before the user arrives, an updated note may be sent to the user. If all the chargers are being used, the server at 406 determines where the user was when the request was sent or received. It is assumed that the user is on his way to the charging station. Thus the location of the user may be obtained from the request or detected from a GPS map being used by the server.

At 408, the server is designed or caused to estimate a time for the user to arrive at the charging location. Given all the statuses of the chargers, the server knows when a next charger will be available as such the estimated time is fairly practical. If the user would arrive earlier than the charger becomes available, the user is advised of such so that the user knows what to do in the interim. In the event that one charger will be available within a time frame (e.g., +or −2 minutes) by the time the user arrives, the system will reserve the charger so that the user can use the charger upon arrival without waiting.

To make the estimated time more accurate, the traffic conditions between the location of the vehicle and the charging station may be utilized in one embodiment to estimate the time for the user to arrive at the charging station. Optionally, the speed the vehicle is moving may also be referenced to fine tune the estimated time. The more accurate the estimate is for the time, the more efficient it is for a reserved charger. At 410, the user is signed up with the server that eventually sends a notification to the user to use which one of the chargers at the chosen charging station.

It can be appreciated by those skilled in the art that part of the process 400 may be applicable to efficiently managing the current situation in which EVs are parked in respective parking spots. An invisible line is formed by drivers courteously recognizing each other on first-come and first-served basis. However, confusion about who goes next for an available charger does happen.

FIG. 4B shows a top-view of an exemplary charging station 420 that includes at least two chargers 422 and 424, and a number of parking spots. When the two chargers 422 and 424 are being occupied, vehicles that need to use the chargers must be in line waiting for a next available charger. To avoid clogging the charging station, these vehicles are often waiting in the available parking spots adjacent to or near the chargers. However, it is confusing to all when more vehicles are waiting as to who came first or who should be the next. When a vehicle arrives at the charging station, a driver of the vehicle just parks wherever he considers convenient. As more vehicles are coming and park in different parking spots, it is difficult, if not possible, to form an invisible line by the vehicles waiting for their turns in the different parking spots.

According to one embodiment, the process 400 can be used for the situation shown in FIG. 4B, where a driver signs in with the charging station upon his arrival. Based on how many vehicles that have arrived earlier than he did, a server is designed to estimate how long the driver has to wait based on the status of each of the chargers at the charging station. Different charging stations may have chargers with different performance, some chargers with enormous power (e.g., voltage and amperage) can charge a vehicle much faster than other chargers do, often resulting in different charging times. When estimating the waiting time for a driver, the server is designed to take all the parameters into consideration and derive the waiting time for each of the waiting vehicles based on when they arrived at the charging station. A fairly accurate estimated time may be sent to the user to let the user know how much time he has to wait. The user may decide what to do while waiting. When it comes to his turn (e.g., an occupied charger is released or about to be released), the server sends a notification to the driver that he can now move his vehicle to the next available charger while others would not receive such a notification, thus the confusion of who shall go for an available charger is minimized.

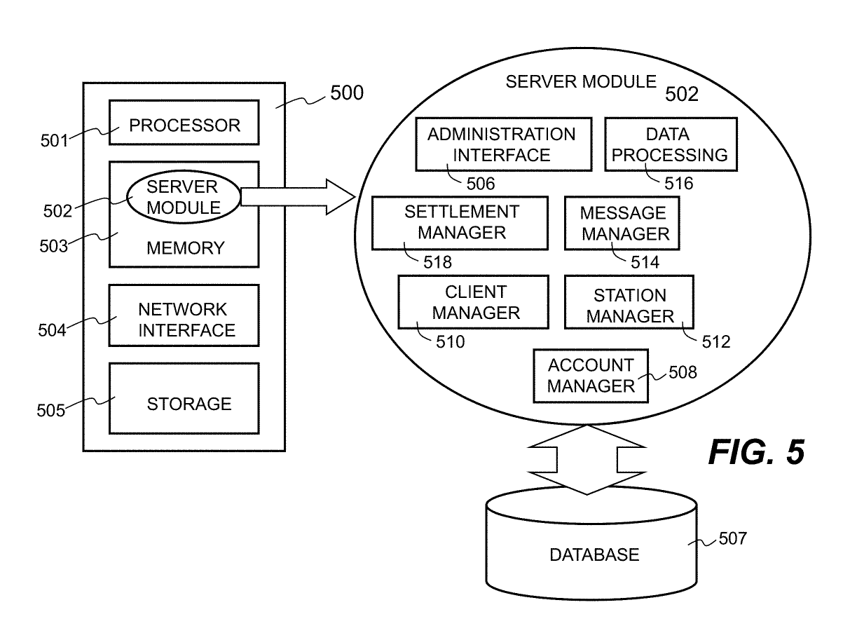

Referring now to FIG. 5, there is shown a functional block diagram of a server 500 in which a server module 502 resides in a memory space 503 and is executed by one or more processors 501. The server 500 is a representation of many similar servers operated by a business running one or more charging stations and may be used in FIG. 1A to facilitate the control of chargers across all charging stations, the collection of vehicle data (e.g., speed, location, driving routes and habits, account and profile for each of owners), the communication with the owners or users coming to a charging station, the allocation of ads for each of users, and the arrangements between advertisers and each of the users, and possible settlements of payments or credits towards the viewing of some of the ads by a user who has opted in for viewing advertisements while waiting for his vehicle being charged.

Depending on implementation, the server 500 may be a single server or a cluster of two or more servers. One embodiment of the present invention is implemented as cloud computing in which there are multiple computers or servers deployed to serve as many businesses or individuals as practically possible. For illustration purpose, a single server 500 is shown in FIG. 5. Further, the server 500 includes a network interface 504 to facilitate the communication between the server 500 and other devices on a network, and a storage device or space 505. In one embodiment, the server module 502 is an executable version of one embodiment of the present invention and delivers, when executed, some or all of the features/results contemplated in the present invention. It should be noted that a general computing device is not able to perform or deliver what the server 500 is equipped to do without the installation of or access to the server module 502.

According to one embodiment, the server module 502 comprises an administration interface 506, an account manager 508, a client (advertiser) manager 510, a charging station manager 512, an message manager 514, a data processing module 516 and a settlement manager 518.

### Administration Interface 506:

As the name suggests, the administration interface 506 facilitates a system administrator to access various components and set up various parameters of the components in the server module 502. In one embodiment in which the operator of the server 500 also sells EV, an example of the operator is Tesla Motors in Silicon Valley of California. When a new EV vehicle is being purchased, the information about the owner (e.g., owner address, driving license, vehicle year, make and model) is entered via the administration interface 506. In operation, the entered information is processed and accessible by some or all of other components in the server 500.

### Account Manager 508:

The account manager 508 is provided to allow a user to automatically register himself with the server 500 for a service being offered by the server 500 or register with a client module or an App running on his mobile device, where the client module is designed to cause his mobile device to communicate with the server 500 via the interface 504. In one example, a user causes the client module to be executed for the first time on his device (e.g., iPhone), the module is designed to request the user to enter certain information (e.g., username/password, a fingerprint, a true name and etc.) before allowing the user to create an account for receiving a service offered by the operator. In one embodiment, a user is allowed to link his electronic wallet (e.g., a credit card or an financial account) to his account. Whenever there is a charge or credit from the operator, the settlement goes to his electronic wallet. After the registration, a profile of the user may be automatically created in the server 500. In operation, the profile is updated over times with information obtained from the user. For example, how often, where and when the user charges his vehicle, his use of GPS system, his starts and destinations and etc. The profile itself derived from an account is confidential but can be used to provide additional services to the user.

### Client Manager 510

The client manager 510 is provided to manage the communication between the server 500 and mobile devices associated with the users. Besides providing the latest version of the client modules or Apps to be running in the mobile devices, the client manager 500 manages the communications with chargers or charging stations. In the embodiment of streaming ads to a user while waiting for his vehicle being charged at a charging station, the client manager 510 is designed to contact advertisers for using an advertising opportunity to feed some appealing advertisements to the user, where the advertisers may bid for the opportunity to advertise their goods or services to the user in accordance with some or all of the profile of the user. Such bidding process may provide the operator some additional revenue or even allow the operator to share a percentage of the fees paid by the advertisers if the user has chosen to opt in for viewing relevant advertisements.

### Charging Station Manager 512

This module is designed or configured to manage all chargers or charging stations across a region. In one embodiment, the manager 512 is designed to communicate with each of the chargers to detect if a charge is being occupied by a vehicle, obtain a charging status of the charger when the charger is being occupied, and if the charger is still being occupied after the vehicle has been charged. In operation, the charging station manager 512 can detect which charger at a charging station is available or becoming available. Operationally, the charging station manager 512 controls how a charger operates (e.g., how much voltage or amperage is provided).

### Messaging Manager 514

The messaging manager 514 is a tool provided to send various notifications to a registered user. In operation, the messaging manager 514 works with the Client manager 510 and the Charging station manager 512 to notify a user, for example, when his vehicle starts being charged, a charging rate (e.g., how much voltage or amperage, and the remaining time to a charging level), when the charging is complete. In particular, the messaging manager 514 reminds the user of removing his vehicle off the charger when it is detected that the charger is still occupied after the vehicle has been charged to a predefined charging level (e.g., full capacity, a percentage of the full capacity set by the user or a level enough to continue on a trip). When the charger has been occupied a certain period after the charging has stopped, the messaging manager 514 notifies the user that a surcharge is being assessed to his account (e.g., a registered credit card). In the event, the user viewed pushed ads and ended up with some interactions (e.g., ordering something from a displayed ad), an acknowledgement is sent to the user via the messaging manager 514.

### Data Processing 516:

This module is designed or configured to perform analytic operations of collected data. In one example, this module determines an estimated time for a user to use a charger at a charging station after the user signs in. In another example, this module determines which advertisement to be shown next after a user has viewed one advertisement. In one embodiment, in reference to the profile of the user, the data processing module 516 determines a set of ads in an order for the user. In operation, the data processing module 516 is designed to be periodically or continuously executed to keep the allocated ads in an order that is believed to be most effective. According to one embodiment, whenever an interaction with a displayed advertisement happens, the data processing module 516 is designed to calculate a set of parameters to reallocate some or all of the ads for the user. In one case, the subsequent similar ads are withdrawn. In another case, the data processing module 516 is designed to calculate a set of parameters to allocate new ads of items or services that could supplement or expand the use of the purchased item by the user. In an example of purchasing a smart TV by a user, once the transaction of the purchase is done, further TV ads would be ignored. Instead, it would be much more efficient or useful to send ads related to a cable service or TV accessories or other services (e.g., HDMI cable, surrounding speaker system or extended warranty). In still another case, the user may want to delete an advertiser (perhaps the user has had a bad experience with a product from the advertiser) or add a preferable advertiser (perhaps the user is fascinated with a brand from the advertiser), the data processing module 516 is designed to calculate a set of parameters that cause to reallocate advertisements for the user every time there is a change to his profile or an action to a viewed advertisement.

Settlement manager 518:

As the name suggests, this module is designed to settle a transaction (e.g., a charge or a credit) with a user while the user uses a charging station. In operation, this module works with the account manager 508 and the data processing unit 516 to ensure a transaction is carried out properly and correctly.

The invention is preferably implemented in software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. For example, the description herein is largely on a user receiving a payment from a publisher or an advertiser for viewing an ad. In different embodiments, various vouchers, rewards, or discounts may be made as part of an incentive for the user to view the ad. Thus the payment described above shall also include other types of incentives for a user to view an ad. Further, the description herein is largely based on viewing an advertisement, those skilled in the art shall appreciate that the description is equally applicable to listening to an ad, an alert or a message. Accordingly, the scope of the present invention is defined by the appended claims rather than the foregoing description of embodiments.

We claim:

1. A method for managing a charging station for electrical vehicles, the method comprising:
detecting whether a vehicle has occupied a charger at the charging station;
requiring a user of the vehicle to sign in with the charging station when the vehicle is detected at the charger;
notifying the user wirelessly from time to time about a charging status of the vehicle;
sending a notification to the user when the vehicle has been charged to a full capacity of battery in the vehicle or to a predefined level; and
charging an account of the user for a fee when the user had not removed the vehicle from the charger after a predefined time.

2. The method as recited in claim 1, further comprising:
receiving a request from an application that the vehicle is on its way to the charging station;
determining an estimated time for the user to use the charger at the charging station;
notifying the user to use the charger when the charger becomes available; and
notifying a next user to use the charger when the user does not occupy the charger within a predefined time.

3. The method as recited in claim 2, wherein the request is sent from a mobile device associated with the user, the request includes a selection of the charging station among other charging stations.

4. The method as recited in claim 3, further comprising:
determining how many chargers are being used at the charging station;
determining when one of the chargers will become available next; and
calculating the estimated time for using the one of the chargers.

5. The method as recited in claim 4, wherein said calculating the estimated time is based upon a location of the vehicle when the request was sent.

6. The method as recited in claim 5, wherein said calculating the estimated time is based upon traffic information between the location and the charging station.

7. The method as recited in claim 1, further comprising:
detecting where the user is when the vehicle is being charged;
streaming in one or more advertisements to a display screen within the vehicle when the user is detected sitting in the vehicle;
displaying one or more advertisements to an application running in a mobile device associated with the user when the user is detected being away from the vehicle being charged at the charger.

8. The method as recited in claim 7, wherein the one or more advertisement are allocated for the user based upon a profile including one or more inputs from the user.

9. The method as recited in claim 8, further comprising updating the profile whenever there is an interaction between the user and a displayed advertisement.

10. The method as recited in claim 1, further comprising: causing the charger to signal to other users waiting at the charging station that the charger is available but occupied by the vehicle.

11. A system for managing a charging station for electrical vehicles, the system comprising:
at least one charger at the charging station, the charger coupled to a data network; and
a detector disposed near the charger, wherein a user of the vehicle is required to sign in with the charging station when the vehicle detects the vehicle occupying the charger, the user is wirelessly notified from time to time about a charging status of the vehicle and the charger causes a notification to be sent to the user when the vehicle has been charged to a full capacity of battery in the vehicle or to a predefined level; and an account of the user is charged for a fee when the user had not removed the vehicle from the charger after a predefined time.

12. The system as recited in claim 11, further comprising:
at least one server managing a plurality of charging stations located remotely with respect to each other, the server communicating with the vehicle and an application running in a mobile device associated with the user.

13. The system as recited in claim 12, wherein the server receives a request from the application that the vehicle is on its way to the charging station, the server is caused to determine an estimated time for the user to use the charger at the charging station, notify the user to use the charger when the charger becomes available; and
notify a next user to use the charger when the user does not occupy the charger within a predefined time.

14. The system as recited in claim 13, wherein the request is sent from a mobile device associated with the user, the request includes a selection of the charging station among other charging stations.

15. The system as recited in claim 13, wherein the server is further caused to:
determine how many chargers are being used at the charging station;
determine when one of the chargers will become available next; and
calculate the estimated time for using the one of the chargers.

16. The system as recited in claim 15, wherein the estimated time is calculated based upon a location of the vehicle when the request was sent.

17. The system as recited in claim 16, wherein the estimated time is calculated based upon traffic information between the location and the charging station.

18. The system as recited in claim 11, wherein the charger is caused to detect where
the user is when the vehicle is being charged, the server communicating with the charger is caused to:
stream in one or more advertisements to a display screen within the vehicle when the user is detected sitting in the vehicle;
display one or more advertisements to an application running in a mobile device associated with the user when the user is detected being away from the vehicle being charged at the charger.

19. The system as recited in claim 18, wherein the one or more advertisement are allocated for the user based upon a profile including one or more inputs from the user.

20. The system as recited in claim 8, further comprising updating the profile whenever there is an interaction between the user and a displayed advertisement.
